(19) United States
(12) Patent Application Publication
(10) Pub. No.: US 2021/0260726 A1
(43) Pub. Date: Aug. 26, 2021

(54) ADJUSTABLE WRENCH COMPRISING A RELEASABLE WORM GEAR

(71) Applicant: STANLEY BLACK & DECKER MEA FZE, Dubau (AE)

(72) Inventors: Philippe PRAUDEL, Long Jumeau (FR); Jocelyn VECCHIO, Vitry Sur Seine (FR); Jean-Christophe HERISSE, Savigny sur Orge (FR)

(21) Appl. No.: 17/261,334

(22) PCT Filed: May 23, 2019
(86) PCT No.: PCT/EP2019/063366

§ 371 Date: Jan. 19, 2021

(30) Foreign Application Priority Data
Jul. 17, 2018 (EP) 18184016.6

(51) Int. Cl. B25B 13/14

(52) U.S. Cl. CPC B25B 13/14

(57) ABSTRACT

The invention deals with an adjustable wrench comprising: a first jaw (8) and a second jaw (10) movable relative to the first jaw (8), wherein the second jaw (10) comprises a rack (12), a worm gear (18) movable into an engaged position wherein the worm gear (18) engages the rack (12) and wherein a rotation of the worm gear (18) causes the second jaw (10) to move relative to the first jaw (8), and into a disengaged position wherein the worm gear (18) does not engage the rack (12), a body (2) defining two surfaces, one of the surfaces comprising a first portion (14a) and a second portion (14b), the other surface comprising a third portion (16a) and a fourth portion (16b), the first portion (14a), the second portion (14b), the third portion (16a) and the fourth portion (16b) comprising a first point (140a), a second point (140b), a third point (160a) and a fourth point (160b) respectively, a biasing element (20) configured to urge the worm gear (18) toward the engaged position by applying forces on both surfaces, the biasing element (20) simultaneously contacting the first point (140a) and the third point (160a) when the worm gear (18) is in a position comprised between the engaged position and an intermediate position, and simultaneously contacting the second point (140b) and the fourth point (160b) when the worm gear (18) is in a position comprised between the intermediate position and the disengaged position, wherein the angle of incline (α) of the first portion (14a) at the first point (140a) relative to the third portion (16a) at the third point (160a) is greater than the angle of incline (β) of the second portion (14b) at the second point (140b) relative to the fourth portion (16b) at the fourth point (160b).

This national phase patent application claims priority to PCT/EP2019/063366, filed May 23, 2019, which claims priority to EP18184016.6, filed Jul. 17, 2018, which are hereby incorporated by reference in their entirety.

### FIELD OF THE INVENTION

The invention deals with an adjustable wrench.

### STATE OF THE ART

A conventional adjustable wrench comprises a first jaw, a second jaw movable relative to the first jaw, and a worm gear. The second jaw comprises a rack. The adjustable wrench comprises a body defining a cavity for receiving the worm gear. The worm gear is rotatably mounted to the body by means of a pin. The pin maintains the worm gear in an engaged position wherein the worm gear engages the rack. A user can rotate the worm gear by hand, which causes causes the second jaw to move relative to the first jaw with. Therefore, the user can adapt the distance between the jaw to the diameter of an object to be grasped between the jaws such as a nut.

However, the movement of the second jaw relative to the first jaw is slow.

To give to a user of the adjustable wrench the possibility to adjust the distance between the two jaws more quickly, it has been proposed to remove the pin so as to allow the worm gear to be moved into a disengaged position wherein the worm gear does not engage the rack. In the disengaged position, the user can manually move the second jaw relative to the first jaw very quickly. Moreover, the pin is replaced by a biasing element configured to urge the worm gear toward the engaged position by applying forces on two planar surfaces facing each other delimiting the cavity wherein the worm gear is received. Thus, the worm gear automatically moves into the engaged position once the user releases it.

However, a problem arising in an adjustable wrench comprising such a biasing element is that the worm gear may not be efficiently stabilized in the engaged position.

The stability of the worm gear in the engaged position could be improved by increasing the angle of incline of one of the two planar surfaces relative to the other surface. However, this would make the cavity much larger, thus making the body of the adjustable wrench bulky. Besides, manipulating the worm gear would be harder since a greater force would be needed to move the worm gear from the engaged position to the disengaged position.

### SUMMARY OF THE INVENTION

A goal of the invention is to improve the stability of a movable worm gear of an adjustable wrench in its engaged position without making the wrench more difficult to manipulate or bulkier.

It is therefore proposed an adjustable wrench according to claim 1.

The adjustable wrench may further comprise additional features recited in the dependent claims.

### DESCRIPTION OF THE FIGURES

Further details, features and advantages of the invention are explained in more detail below with the aid of the exemplary embodiments of the invention that are illustrated in the figures in which:

FIG. 1 is a side view of an adjustable wrench according to an embodiment set in a first state.

FIG. 2 is a side view of the adjustable wrench of FIG. 1, set in a second state.

FIG. 3 is a longitudinal sectional view of a body of the adjustable wrench of FIG. 1 when the adjustable is in the first state.

FIG. 4 is a longitudinal sectional view of a body of the adjustable wrench of FIG. 1 when the adjustable is in the second state.

FIG. 5 is another longitudinal sectional view of a body of the adjustable wrench of FIG. 1.

FIG. 6 is a schematic view of a profile of the body depicted in FIG. 5.

FIG. 7-10 show forces applied in the adjustable wrench set in four different states.

FIG. 11 shows the evolution of a force applied in the adjustable wrench of FIG. 1 from the state of FIG. 7 to the state of FIG. 10.

FIG. 12 shows the evolution of a force applied in a known adjustable wrench.

Similar features have identical numbers in all figures.

### DETAILED DESCRIPTION OF AT LEAST ONE EMBODIMENT

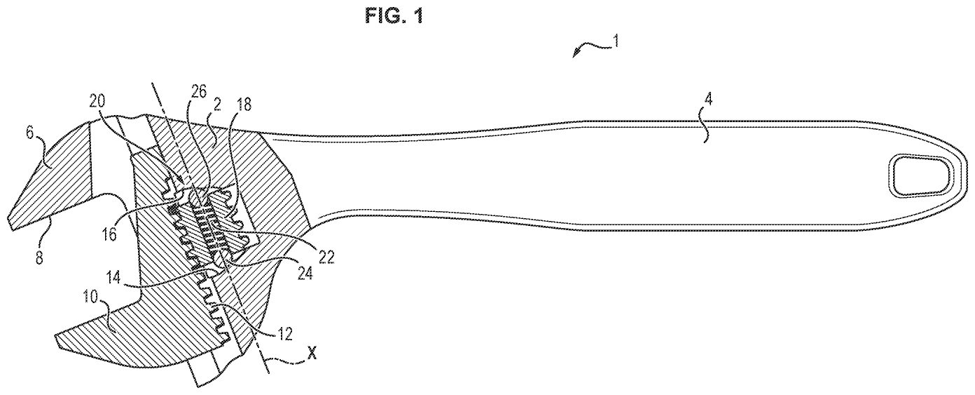

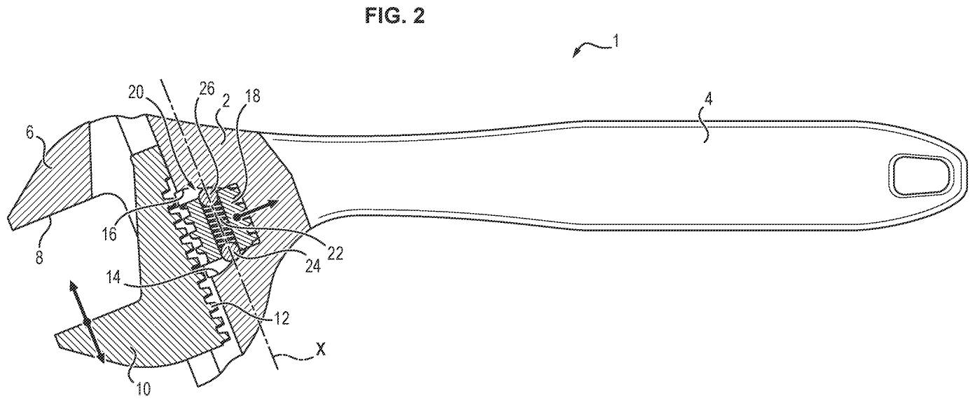

Referring to FIGS. 1 and 2, an adjustable wrench 1 comprises a body 2.

The body 2 comprises a proximal portion 4 comprising a handle a user can grasp, and a distal portion 6 comprising a first jaw 8.

The adjustable wrench 1 further comprises a second jaw 10 movable relative to the first jaw 8. The second jaw 10 is arranged to slide relative to the first jaw 8 in a direction of translation.

The first jaw 8 and the second jaw 10 face each other so as to grasp an object like a nut. The distance between the jaws 8, 10 can be adjusted by moving the second jaw 10 relative to the first jaw 8.

The second jaw 10 comprises a rack 12. The rack 12 comprises a plurality of teeth extends along the direction of translation of the second jaw 10 relative to the first jaw 8.

Besides, the body 2 defines two support surfaces 14, 16 facing each other, so as to delimit a cavity between both support surfaces 14, 16. The cavity has an opening covered by the rack 12 of the second jaw 10.

The adjustable wrench 1 comprises a worm gear 18.

The worm gear 18 is rotatable relative to the body 2 about a rotation axis X which is parallel to the direction of translation. The worm gear 18 is arranged in the cavity such that a user can touch two opposite sides of the worm gear 18 with two fingers and manually rotate the worm gear 18 relative to the body 2.

The worm gear 18 is movable between an engaged position and a disengaged position.

In the engaged position, shown in FIG. 1, the worm gear 18 engages the rack 12. The mechanical engagement of the worm gear 18 with the rack 12 prevents a user to manually move the second jaw 10 relative to the first jaw 8. Nonetheless, a rotation of the worm gear 18 in the engaged position relative to the body 2 about the rotation axis X causes the second jaw 10 to move relative to the first jaw 8, so as to close or open the jaws 8, 10. The engaged position offers to a user of the adjustable wrench 1 a first method to adjust with high precision the distance between the two jaws 8, 10.

In the disengaged position, shown in FIG. 2, the worm gear 18 does not engage the rack 12, leaving the second jaw 10 free to move relative to the first jaw 8, such that the user can directly seize the second jaw 10 and move it toward or away from the first jaw 8. Besides, the worm gear abuts against a bottom of the cavity defined by body 2. The disengaged position offers to a user of the adjustable wrench 1 a second method to open and close the jaws 8, 10 with less precision but much quicker than the first method.

The worm gear 18 has an annular body 2 comprising an external thread. The external thread engages the teeth of the rack 12 in the engaged position.

The annular body 2 defines a through opening. The rotation axis X of the worm gear 18 relative to the body 2 is a central axis of the through opening. The through opening is cylindrical.

The adjustable wrench 1 further comprises a biasing element 20 configured to urge the worm gear 18 toward the engaged position by applying forces on both support surfaces 14, 16 delimiting the cavity.

The biasing element 20 is arranged at least in part in the through opening.

The biasing element 20 comprises a compression spring 22 and two balls 24, 26. The first ball 24 is affixed to a first end of the compression spring 22, and the second ball 26 is affixed to a second end of the compression spring 22, the second end being opposite to the first end. The compression spring 22 is arranged to simultaneously urge the first ball 24 towards support surface 14 and the second ball 26 on support surface 16.

Generally speaking, the urging effect of the biasing element 20 on the worm gear 18 can be obtained by arranging the two support surfaces 14, 16 such that the distance between the two support surfaces 14, 16 measured in the direction of translation of the rack 12 keeps decreasing when the worm gear 18 is moved from the engaged position to the disengaged position. When the worm gear 18 is moved from the engaged position to the disengaged position, the compression spring 22 is compressed, and when the worm gear 18 is moved from the disengaged position to the engaged position, the compression 22 automatically expands.

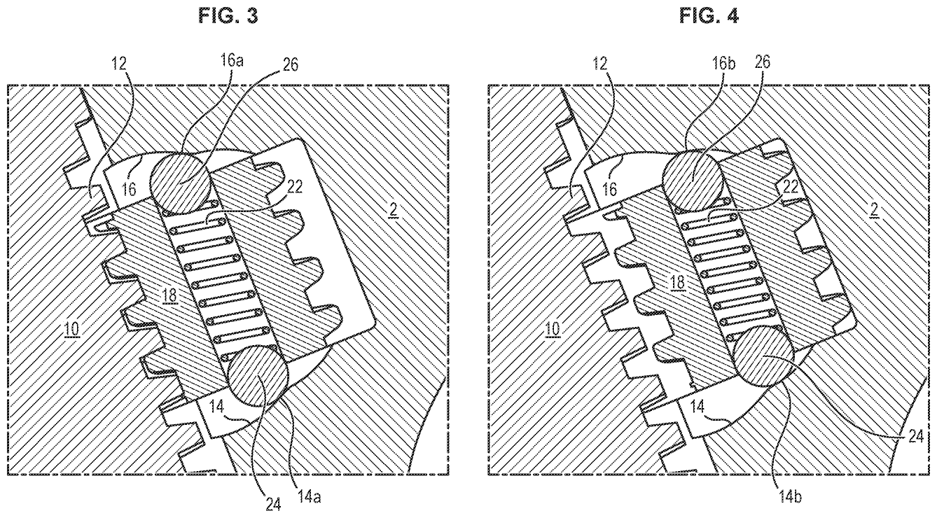

Now, the design of the two support surfaces 14, 16 will be described with more details in relation with FIGS. 3, 4 and 5.

Support surface 14 comprises a first portion 14a and a second portion 14b.

The first portion 14a is planar. The second portion 14b is planar as well.

The first portion 14a and the second portion 14bs are connected to each other by a line forming an edge 14c. This line is perpendicular to the direction of translation of the second jaw 10 relative to the first jaw 8. The first portion 14a and the second portion 14b are secant.

Similarly, support surface 16 comprises a third portion 16a and a fourth portion 16b. The third portion 16a faces the first portion 14a and the fourth portion 16b faces the second portion 14b.

The third portion 16a is planar. The fourth portion 16b is planar as well.

The third portion 16a and the fourth portion 16bs are connected to each other by a line forming an edge 16c. This line is perpendicular to the direction of translation of the fourth jaw relative to the third jaw. The third portion 16a and the fourth portion 16b are secant.

The two edges 14c, 16c faces each other.

The worm gear 18 can be set an intermediate position between the engaged position and the disengaged position. In the intermediate position, the biasing element 20 (more precisely its two balls 24, 26) is in contact with the two lines forming edges 14c, 16c simultaneously.

The first portion 14a and the third portion 16a are mirror-symmetric.

The second portion 14b and the fourth portion 16b are also mirror-symmetric.

In fact, support surfaces 14, 16 can be entirely mirror-symmetric.

When the worm gear 18 is in a position comprised between the engaged position and the intermediate position, the biasing element 20 simultaneously contacts a point 140a of the first portion 14a and a point 160a of the third portion 16a.

The angle of incline of the first portion 14a at point 140a relative to the third portion 16a at point 160a is noted α. In this application, the angle of incline at a given point of a surface relative to another point of another surface is the angle between the tangents of the surfaces in said points.

The angle of incline α is comprised between 40 and 60 degrees, preferably 50 degrees.

When the first portion 14a and the third portion 16a are planar, the angle of incline α corresponds to the angle between the third portion 16a as a whole and the fourth portion 16b as a whole.

When the worm gear 18 is in a position comprised between the intermediate position and the disengaged position, the biasing element 20 simultaneously contacts a point 140b of the second portion 14b and a point 160b of the fourth portion 16b.

The angle of incline of the second portion 14b at point 140b relative to the fourth portion 16b at point 160b is noted β.

When the second portion 14b and the fourth portion 16b are planar, the angle of incline β corresponds to the angle between the second portion 14b as a whole and the fourth portion 16b as a whole.

The angle of incline β is smaller than the angle of incline α.

The angle of incline β is comprised between 10 and 30 degrees, preferably 20 degrees.

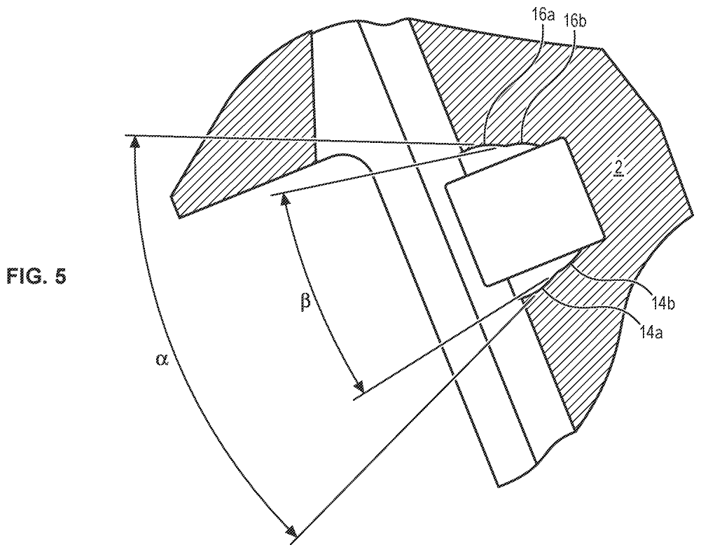

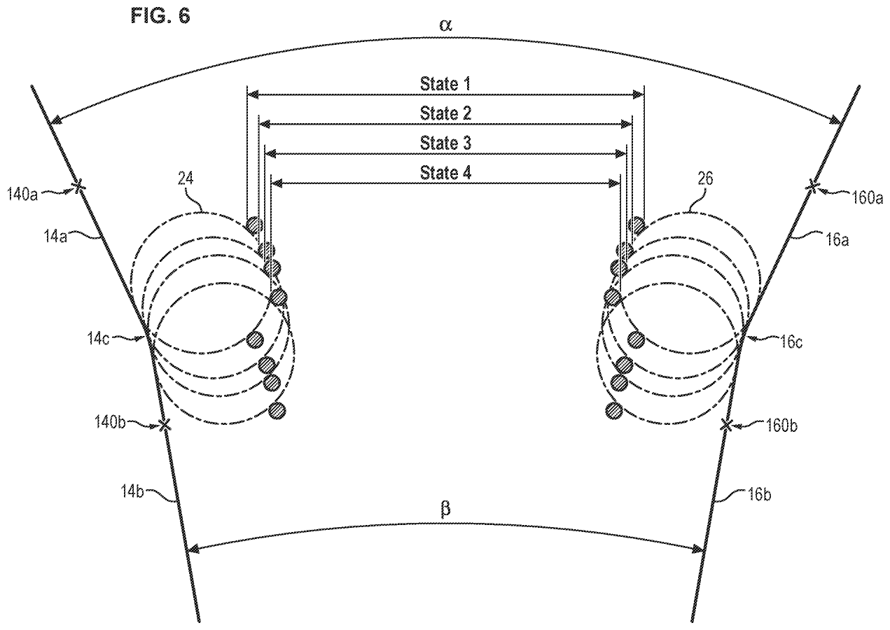

FIG. 6 schematically represents the biasing element 20 in four different states corresponding to four different positions of the worm gear 18 between the engaged position and the disengaged position. In this figure, balls 24, 26 are represented by two big circles and the compression spring 22 is represented by two solid lines, wherein each solid line is terminated at its two opposite ends by two smaller circles.

“State 1” is the state of the biasing element 20 while the worm gear 18 is in the engaged position. In state 1, the balls 24, 26 of the biasing element 20 contact a point of the first portion 14a and a point of the third portion 16a, respectively. Said points are away from the two edges. In state 1, the compression spring 22 has a first length (measured from one of its two ends to the opposite end).

“State 2” is the state of the biasing element 20 once a user has moved the worm gear 18 in a first position comprised between the engaged position and the intermediate position. In state 2, the balls 24, 26 of the biasing element 20 contact a point of the first portion 14a and a point of the third portion 16a, respectively, which are closer to the two edges than the contact points of the balls 24, 26 in state 1. In state 2, the compression spring 22 has a second length smaller than the first length, due to angle of incline α.

“State 3” is the state of the biasing element 20 once a user has moved the worm gear 18 further towards the disengaged position, once. In state 3, the balls 24, 26 of the biasing element 20 the balls 24, 26 have crossed the two edges 14c, 16c, thus contact a point of the second portion 14b and a point of the fourth portion 16b, respectively. In state 3, the compression spring 22 has a third length smaller than the second length, due to angle of incline β.

“State 4” is the state of the biasing element 20 while the worm gear 18 is in the disengaged position. In state 4, the balls 24, 26 of the biasing element 20 contact another point of the second portion 14b and another point of the fourth portion 16b which are farther away from the two edges than the contact points of state 3. In state 4, the compression spring 22 has a fourth length smaller than the third length, due to angle of incline β.

Since α<β, it can be observed that the length of the compression spring 22 decreases more quickly when balls 24, 26 slide along the first and third portions 14a, 16a (between states 1 and 2) than when the balls 24, 26 slide along the second and fourth portions 14b, 16b (between states 3 and 4).

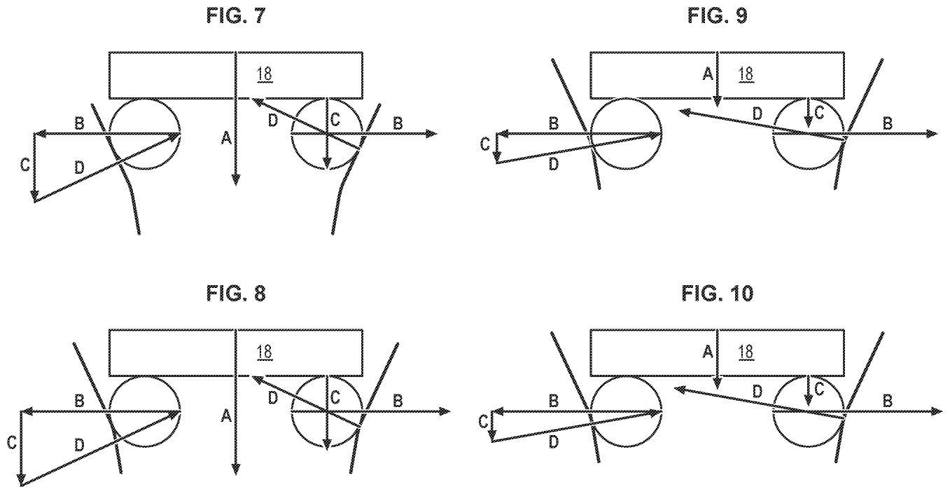

FIG. 7-10 depicts forces applied in states 1, 2, 3 and 4 by a biasing element 20 wherein the compression spring 22 has a stiffness K=1.0506 N/mm, a free length Lo=23.9 mm and a diameter of 0.55 mm, and wherein the balls 24, 26 have a diameter of 5 mm.

B is the force applied by the compression spring 22 on ball 24 or 26.

C is a reaction force applied by the worm gear 18 on ball 24 or 26.

D is the reaction force applied by the body 2 defining both support surfaces 14, 16 on a ball 24 (D+B+C=0).

A=2×C is the force in contact between the second jaw 10 and the worm gear 18.

The table below summarizes numerical values of forces A, B in states 1, 2, 3, 4:

| | Force | Force | Spring 22 |
|---|---|---|---|
| State | A (N) | B (N) | length (mm) |
| 1 | 9.645 | 10.342 | 14.056 |
| 2 | 10.461 | 11.217 | 13.223 |
| 3 | 4.101 | 11.630 | 11.7 |
| 4 | 4.228 | 11.99 | 11.417 |

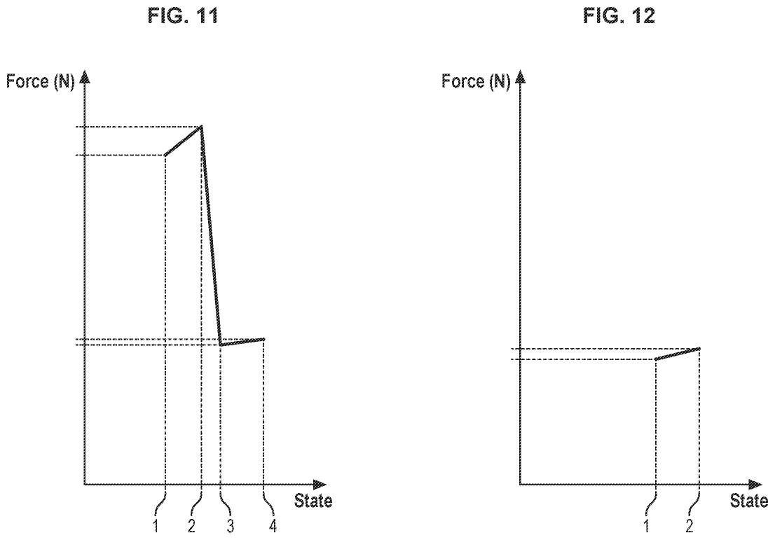

Evolution of force A from the state 1 (when the worm gear 18 push on the second jaw 10 in the engaged position) to the state 4 (when the worm gear 18 is fully pull back in the disengaged position) is shown in FIG. 11. Force A increases from state 1 to state 2, which allows the worm gear 18 to be efficiently stabilized in the engaged position. Force A decreases in a significant manner from state 2 to state 3 so as to reach a value much lower than that of state 1, then increases again from state 3 to state 4 because of the two different angles of incline α, β. This makes the worm gear 18 easier to manipulate.

For comparison, evolution of force A from the state 1 (when the worm gear 18 push on the second jaw 10 in the engaged position) to the state 4 (when the worm gear 18 is fully pull back in the disengaged position) in a known adjustable wrench 1 having a single angle of incline of 20 degrees between the two support surfaces 14, 16 and the same biasing element 20 is shown in FIG. 12. The force of contact between the worm gear 18 and the movable jaw A is too low. This situation doesn't allow to have an efficient stability of the mechanism. If the spring 22 is designed to cause force A to be very high at state 1, pulling back the worm gear 18 is uneasy because of strong force until state 2. Force A at state 1 could also be adjusted at a high value by increasing the single angle of incline between the two support surfaces 14, 16, for instance at 50 degrees. However, this would make the cavity much larger, thus the body 2 defining both support surfaces 14, 16 would be very bulky.

When portions 14a, 16a are planar, the direction of at least force B does not change between state 1 and state 2 (i.e. when the position of the worm gear is between the engaged position and the intermediate position). Similarly, when portions 14b, 16b, are planar, the direction of at least force B does not change between state 1 and state 2 (i.e. when the position of the worm gear is between the intermediate position and the disengaged position and).

The invention is not limited to the first embodiment illustrated in the figures.

The first portion 14a, the second portion 14b, the third portion 16a and the fourth portion 16b do not need to be planar, as long as said portions comprise at least a first point 140a, a second point 140b, a third point 160a and a fourth point 160b, respectively, fulfilling the following condition: the angle of incline of the first portion 14a at the first point 140a relative to the third portion 16a at the third point is greater than the angle of incline of the second portion 14b at the second point relative to the fourth portion 16b at the fourth point 16b. A non-planar portion does not have a constant angle of incline for all points of the portion, but different angle of inclines at different points of said portion.

In non-illustrated embodiments, at least one of the first, second, third and fourth portion may for instance be curved.

In a second embodiment, the first, second, third and fourth portions may are concave. In other words, each of these surface form a concavity. Such a shape is easier to manufacture by milling.

In a third embodiment, the first, second, third and fourth portions are convex. The worm gear is stabilized in the engaged position more efficiently in this third embodiment than in the second embodiment. The first and second portions may for instance be connected to each other by a line forming an edge or may be connected to each other in a continuous manner, i.e. without any edge. Similarly, the third and fourth portions may for instance be connected to each other by a line forming an edge or may be connected to each other in a continuous manner, i.e. without any edge.

What is claimed:

1. An adjustable wrench comprising:
a first jaw (8) and a second jaw (10) movable relative to the first jaw (8), wherein the second jaw (10) comprises a rack (12),
a worm gear (18) movable into an engaged position wherein the worm gear (18) engages the rack (12) and
wherein a rotation of the worm gear (18) causes the second jaw (10) to move relative to the first jaw (8), and
into a disengaged position wherein the worm gear (18) does not engage the rack (12),
a body (2) defining two surfaces, one of the surfaces comprising a first portion (14a) and a second portion (14b), the other surface comprising a third portion (16a) and a fourth portion (16b), the first portion (14a), the second portion (14b), the third portion (16a) and the fourth portion (16b) comprising a first point (140a), a second point (140b), a third point (160a) and a fourth point (160b) respectively,
a biasing element (20) configured to urge the worm gear (18) toward the engaged position by applying forces on both surfaces, the biasing element (20) simultaneously contacting the first point (140a) and the third point (160a) when the worm gear (18) is in a position comprised between the engaged position and an intermediate position, and simultaneously contacting the second point (140b) and the fourth point (160b) when the worm gear (18) is in a position comprised between the intermediate position and the disengaged position,
characterized in that the angle of incline (α) of the first portion (14a) at the first point (140a) relative to the third portion (16a) at the third point (160a) is greater than the angle of incline (β) of the second portion (14b) at the second point (140b) relative to the fourth portion (16b) at the fourth point (160b).

2. The adjustable wrench according to claim 1, wherein the angle of incline (α) of the first portion (14a) at the first point relative to the third portion (16a) at the third point is comprised between 40 and 60 degrees.

3. The adjustable wrench according to claim 2, wherein the angle of incline (α) of the first portion (14a) at the first point relative to the third portion (16a) at the third point is 50 degrees.

4. The adjustable wrench according to claim 1, wherein the angle of incline (β) of the first portion (14a) at the first point relative to the third portion (16a) at the third point is comprised between 10 and 30 degrees.

5. The adjustable wrench according to claim 4, wherein the angle of incline (β) of the first portion (14a) at the first point relative to the third portion (16a) at the third point is 20 degrees.

6. The adjustable wrench according to claim 1, wherein the first portion (14a) and the third portion (16a) are planar.

7. The adjustable wrench according to claim 1, wherein the second portion (14b) and the fourth portion (16b) are planar.

8. The adjustable wrench according to claims 6 and 7 combined, wherein the second portion (14b) connects the first portion (14a) in a line forming an edge (14c), and the fourth portion (16b) connects the third portion (16a) in another line forming an edge (16c), wherein the biasing element (20) applies simultaneous forces on both edges (14c, 16c) when the worm gear (18) is in the intermediate position.

9. The adjustable wrench according to claim 1, wherein the first portion (14a) and the third portion (16a) are curved.

10. The adjustable wrench according to claim 1, wherein the second portion (14b) and the fourth portion (16b) are curved.

11. The adjustable wrench according to claim 1, wherein the first portion (14a) and the third portion (16a) are mirror-symmetric.

12. The adjustable wrench according to claim 1, wherein the second portion (14b) and the fourth portion (16b) are mirror-symmetric.

13. The adjustable wrench according to claim 1, wherein the biasing element (20) comprises two balls (24, 26) and a compression spring (22), wherein the compression spring (22) is arranged to urge one of the balls (24) towards one of the two surfaces (14) and the other ball (26) on the other surface (16).

14. The adjustable wrench according to claim 1, wherein the worm gear (18) has a through opening and the biasing element (20) is arranged at least in part in the through opening.

15. The adjustable wrench according to claim 14, wherein the worm gear (18) is rotatable relative to the body (2) about a central axis (X) of the through opening.
